(19) United States
(12) Patent Application Publication
(10) Pub. No.: US 2023/0003872 A1
(43) Pub. Date: Jan. 5, 2023

(54) TRACKING OBJECTS WITH RADAR DATA

(71) Applicant: Zoox, Inc., Foster City, CA (US)

(72) Inventors: Jifei Qian, Campbell, CA (US); Joshua Kriser Cohen, Sunnyvale, CA (US); Chuang Wang, Sunnyvale, CA (US)

(73) Assignee: Zoox, Inc.

(21) Appl. No.: 17/364,603

(22) Filed: Jun. 30, 2021

(51) Int. Cl. G01S 13/72; G01S 13/931; G01S 7/41; G06N 20/00

(52) U.S. Cl. CPC G01S 13/723; G01S 13/931; G01S 7/415; G06N 20/00; G01S 7/417

(57) ABSTRACT

Sensors, including radar sensors, may be used to detect objects in an environment. In an example, a vehicle may include one or more radar sensors that sense objects around the vehicle, e.g., so the vehicle can navigate relative to the objects. A plurality of radar points from one or more radar scans are associated with a sensed object and a representation of the sensed object is determined from the plurality of radar points. The representation may be compared to track information of previously-identified, tracked objects. Based on the comparison, the sensed object may be associated with one of the tracked objects, and, alternatively, the track information may be updated based on the representation. Conversely, the comparison may indicate that the sensed object is not associated with any of the tracked objects. In this instance, the representation may be used to generate a new track, e.g., for the newly-sensed object.

### BACKGROUND

Planning systems for autonomous vehicles can utilize information associated with objects in an environment to determine actions relative to those objects. For example, some existing planning systems for autonomous vehicles consider movement of objects, such as other vehicles on the road, when determining maneuvers for the autonomous vehicle to traverse through the environment. Conventional systems may rely on different types of data to determine information about the object(s). However, some conventional systems have not utilized radar data to track objects as they move relative to the autonomous vehicle, at least because the conventional systems have considered radar data on a per-point basis, which requires larger processing times and/or decreased efficiency in identifying and/or characterizing objects that may be potential obstacles to safe travel.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic representation illustrating example systems and techniques for using radar data to track objects in an environment, as described herein.

FIG. 2 includes textual and visual flowcharts to illustrate an example method for associating radar data with a track of a detected object, as described herein.

FIG. 3 includes textual and visual flowcharts to illustrate an example method for generating an object track based at least in part radar data generated by radar sensors on a vehicle, as described herein.

FIG. 4 is a block diagram illustrating an example computing system for using radar data to track objects, as described herein.

FIG. 5 is a flowchart illustrating an example method for tracking objects using radar data, as described herein.

FIG. 6 is a flowchart illustrating an example method of generating tracks for sensed objects using radar data, as described herein.

FIG. 7 is a flowchart illustrating an example method for controlling a vehicle, such as an autonomous vehicle, relative to a tracked object, as described herein.

### DETAILED DESCRIPTION

Techniques described herein are directed to characterizing movement of objects in in an environment based on radar data. For example, in implementations described herein, techniques may be used to determine radar returns that are associated with an object in an environment of the sensor, and use those returns to track the sensed object. Although many systems may benefit from the techniques described herein, an example system that implements the techniques of this disclosure may include an autonomous vehicle having multiple radar sensors (and/or sensors of other or different modalities). In one such example the autonomous vehicle can include multiple radar sensors having overlapping fields of view. A first sensor, can capture first sensor data, e.g. as a radar scan (which may include a collection of a number of measurements of radar returns as data points), of an environment and a second sensor can capture second sensor data, e.g., a second radar scan (which may include a second collection of measurements of radar returns as data points) of the environment. Each of the first scan and the second scan may return a number of points, each having associated information. Such information may include position information, e.g., a location of the point relative to the sensor, the vehicle, and/or in a coordinate system (any or all of which may be determined based on a range and/or azimuth angle of the signal), signal strength information, e.g., a radar cross-section (RCS) value, or velocity information, e.g., a velocity of the point relative to the sensor.

In examples described herein, track association techniques can be used to associate returns in the radar scans to objects in the environment. For example, clustering techniques can be used to group points in the first scan with points in the second scan according to any of the information received with the returns. By way of non-limiting example, points in a similar area, e.g., having close locational proximity, may be candidates for clustering as all being related to a single object. However, in other implementations, the signal strength information, RCS, the velocity information, and/or other information determined by the one or more sensors may also or alternatively be used to cluster points according to implementations of this disclosure. For example, the signal strength may be useful to differentiate between a person standing at a street corner and a light post upon which the person is leaning. For instance, points in the first scan and in the second scan having similar characteristics, e.g., location, signal strength, velocity, may be aggregated as a point cluster, to yield a robust representation of the sensed object. In at least some instances, the multiple scans, e.g., sequential scans of the first sensor and/or the second sensor may be aggregated in a cluster associated with an object.

In example implementations, a machine-trained model can aggregate radar returns (e.g., associated with the object) and generates a representation of the object based thereon. The machine-trained model may generate a two-dimensional representation of the object, e.g., as a bounding box, for a plurality of returns. The representation can include information about the object, including but not limited to a velocity of the object, a classification of the object, extents of the object, a position of the object, or the like. For example, the machine-trained model can receive the radar data (e.g., a single instance or multiple instances of the radar data) and output the representation and associated information.

Techniques described herein also include comparing a representation of a sensed object generated from radar data to information about one or more previously-sensed objects. For instance, the representation generated from the sensor data may be compared to track information, e.g., an expected or predicted state of a previously-detected object. Without limitation, the track information can be based on previous sensor data, including but not limited to previous sensor data generated by the radar sensor(s) and/or by one or more additional or other sensor modalities (e.g., LiDAR sensors, image sensors, or the like).

The techniques described herein can compare the representation generated from the radar sensor data to the track information using a number of techniques. In one non-limiting example, a velocity of the sensed objects, e.g., a velocity of the representation, can be compared to a velocity (an expected velocity) of the tracked object. In other examples, the position of the sensed object can be compared to a position (or expected position) of the tracked object. For instance, the positions may be positions in a two-dimensional space of a center of the representation of the sensed object and/or the tracked object. In still further examples, techniques described herein can determine an intersection over union of the representation of the sensed object from the radar data and a representation of the tracked object. Other comparisons can also be used.

In examples, the techniques described herein can use the results of comparison of the representation generated from the radar sensor data to the track information to associate the sensed object with an existing track. For instance, if the comparison indicates that the sensed object likely corresponds with a track of a previously-identified object, techniques described can use the representation based on the radar data to update the track information, e.g., by predicting future behavior of the object based on updated information about the track. In examples, the sensed object may be likely to correspond to a track when the velocities, positions, and/or other attributes of the representation of the sensed object are closely related (e.g., within a threshold) of corresponding attributes of the tracked object. Without limitation, a sensed object may be associated with a tracked object if the velocity of the sensed object is within a threshold velocity of a track velocity of the tracked object and/or if a position of the sensed object is within a threshold distance of a track position of the tracked object. In still further examples, a sensed object may be associated with a tracked object if the intersection over union of the two-dimensional representation of the sensed object and a two-dimensional representation of the tracked object is equal to or above a threshold value.

In instances in which a sensed object is not associated with an existing track, the radar data, e.g., the representation of the radar data, may be used to generate a new track. For instance, the representation of the radar data may be used as an estimate of the state of a new object, and subsequent radar data (including subsequent representations of sensor data) may be used to refine the track. In some instances, radar data may be used independently of other data, e.g., because radar may often be the first modality to detect an object, especially when the object is at a relatively far distance and/or when the object is occluded. In other examples, the radar data, e.g., the representation of the radar data, may be combined with other data to generate a new track (for a newly-detected object).

Conventionally, object tracking may have been conducted at the exclusion of radar data. For instance, some conventional techniques may associate radar points with objects and process each of those points individually. This “per-point” processing is resource and time intensive, e.g., because it includes determining, for each point, whether the point is associated with an object track. In contrast, techniques described herein can generate a (single) representation of an object from a plurality of radar returns, and use only the representation to track objects or to generate new tracks for newly-sensed objects. In examples, the representation can be based on returns from a single radar scan and/or from a plurality of radar scans, e.g., from multiple radar sensors and/or from multiple scans from the same radar sensor.

In some examples, after a track is updated or generated based on a representation of an object generated from the radar data, aspects of this disclosure can include determining one or more trajectories for proceeding relative to the object. In some instances, the representation information generated according to techniques described herein may be combined, or fused, with data from other sensor modalities to predict a movement of the object and/or to plan a path relative to the object.

Techniques described herein are directed to leveraging sensor and perception data to enable a vehicle, such as an autonomous vehicle, to navigate through an environment while circumventing objects in the environment. Techniques described herein can utilize information sensed about the objects in the environment, e.g., by radar sensors, to more accurately determine movement associated with the object. For example, techniques described herein may be faster than conventional techniques, as they may alleviate the need for information from a plurality of different sensors. That is, techniques described herein provide a technological improvement over existing object detection, classification, prediction and/or navigation technology. In addition to improving the accuracy with which sensor data can be used to determine objects and correctly characterize motion of those objects, techniques described herein can provide a smoother ride and improve safety outcomes by, for example, more accurately providing safe passage to an intended destination.

While this disclosure uses an autonomous vehicle in examples, techniques described herein are not limited application in autonomous vehicles. For example, any system that uses radar data to navigate an environment may benefit from the radar data processing techniques described. By way of non-limiting example, techniques described herein may be used on aircrafts, e.g., to identify other aircraft and/or moving objects. Moreover, non-autonomous vehicles could also benefit from techniques described herein, e.g., for collision detection and/or avoidance systems.

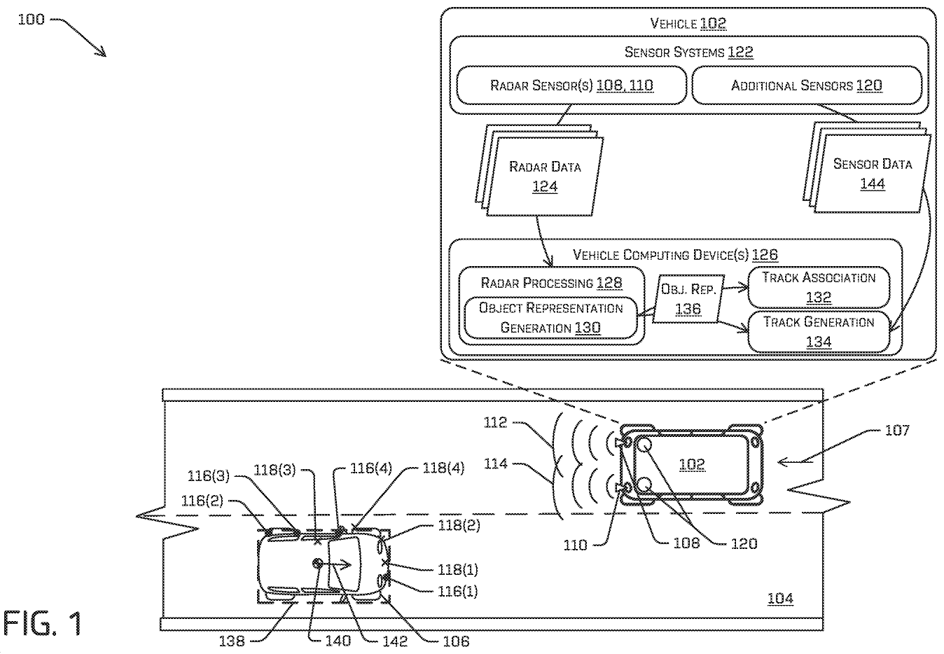

FIGS. 1-6 provide additional details associated with techniques described herein. More specifically, FIG. 1 is a schematic illustration showing an example scenario 100 in which a vehicle 102 is driving on a road surface 104. As illustrated, a second vehicle 106 is also travelling on the road surface 104. In the example scenario 100, the vehicle 102 is moving generally in the direction of arrow 107 and the second vehicle 106 is travelling generally in an opposite direction. For instance, the vehicle 102 and the second vehicle 106 may be driving in opposite lanes, e.g., passing each other.

For illustration, the vehicle 102 can be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such an example, since the vehicle 102 can be configured to control all functions from start to stop, including all parking functions, it can be unoccupied. Additional details associated with the vehicle 102 are described below. However, the vehicle 102 is merely an example, and the systems and methods described herein can be incorporated into any ground-borne, airborne, or waterborne vehicle, including those ranging from vehicles that need to be manually controlled by a driver at all times, to those that are partially or fully autonomously controlled. In additional implementations, techniques described herein may be useful in settings other than vehicles. The techniques described in this specification may be useful in many different applications in which sensor data is used to determine information about objects in an environment.

The vehicle 102 may include a plurality of sensors, including a first radar sensor 108 and a second radar sensor 110. As illustrated, the first radar sensor 108 and the second radar sensor 110 are arranged to propagate waves generally in a direction of travel of the vehicle 102 (e.g., generally along the direction of the arrow 107). As also illustrated, the first radar sensor 108 and the second radar sensor 110 have overlapping fields of view. Accordingly, first emitted radio waves 112, emitted by the first radar sensor 108, will reflect off the second vehicle 106 and return to the first radar sensor 108 where they are detected via a first radar scan. Similarly, second emitted radio waves 114, emitted by the second radar sensor 110, will also reflect off the second vehicle 106 and return to the second radar sensor 110 where they are detected via a second radar scan. In some examples, the first radar sensor 108 and the second radar sensor 110 may be substantially identical, except for their position on the vehicle 102. In other examples, however, the radar sensors 108, 110 may be differently configured. By way of non-limiting example, the radio waves 112, 114 may be emitted at different frequencies, e.g. pulse-regulated frequencies. Also in examples, the radar sensors 108, 110 may be configured such that scans at the sensors 108, 110 have a different interval, e.g., a Doppler interval. In examples, features of the radar sensors 108, 110, including but not limited to the center frequency, the scan type, the scan pattern, frequency modulation, the pulse repetition frequency, pulse repetition interval, may be configured, e.g., to create the different Doppler intervals. Accordingly, the radar sensors 108, 110 may both be disposed to sense objects generally in the same direction relative to the vehicle 102, but the radar sensors 108, 110 can be configured differently. In other examples, however, several features and functions of the radar sensors 108, 110 may be the same or similar.

The sensors 108, 110 may receive the emitted radio waves 112, 114 after the waves reflect off a surface in the environment, e.g., a surface of the second vehicle 106, and the radar sensors 108, 110 can generate radar data based on the reflection. For instance, the radar data may include diverse types of information, including but not limited to a velocity associated with each of many points representative of surfaces or objects in the environment of the sensor. By way of non-limiting example, when the sensors 108, 110 are pulse-Doppler sensors, the sensors 108, 110 may be able to determine a velocity of an object relative to the respective sensor.

In more detail, FIG. 1 illustrates a plurality of first radar returns, schematically represented by points. In the illustration, first points 116(1), 116(2), 116(3), 116(4) (collectively, the first points 116) are illustrated as circles, and represent radar returns associated with the first radar sensor 108. That is, individual of the first points 116 are indicative of locations on the second vehicle 106 at which the first emitted waves 112 reflect. Similarly, second points 118(1), 118(2), 118(3), 118(4) (collectively the second points 118) are illustrated as “X”s, and represent radar returns associated with the second radar sensor 110. Stated differently, individual of the second points 118 are indicative of locations on the second vehicle 106 at which the second emitted waves 114 reflect.

As also illustrated in FIG. 1, the vehicle 102 also includes a plurality of additional sensors 120. The additional sensors 120 may be disposed to sense objects generally in the same direction as the first radar sensor 108 and/or the second radar sensor 110, e.g., generally in the direction of the arrow 107. Without limitation, the additional sensors 120 may be one or more of additional radar sensors, LiDAR sensors, imaging sensors (e.g., cameras), time-of-flight sensors, sonar sensors, thermal imaging devices, or any other sensor modalities. Although two instances of the additional sensors 120 are illustrated in FIG. 1, the vehicle 102 may include any number of additional sensors, with any number of different modalities. In examples, the first radar sensor 108, the second radar sensor 110, and illustrated additional sensors 120 may be disposed generally to detect objects in the direction of the arrow 107, e.g., the second vehicle 106, and the vehicle 102 may include a number of additional sensors disposed to detect objects at other relative positions. Without limitation, the vehicle 102 can include radar sensors and additional sensors that provide for sensing objects at 360-degrees relative to the vehicle 102.

As illustrated in the block diagram accompanying FIG. 1, the first radar sensor 108, the second radar sensor 110, and the additional sensors 120 represent types of sensor systems 122 on the vehicle 102. The first radar sensor 108 and the second radar sensor 108 generate radar data 124. In examples, the radar data 124 includes position data of the respective points 116, 118. For example, information associated with radar returns from the points 116, 118 may include information indicative of a location in the environment, e.g., a location of the points 116, 118. Moreover, when such points are associated with the second vehicle 106, as in the illustration, a position of the second vehicle 106 can be determined. The location information may include a range and azimuth relative to the points 116, 118 or a position in a local or global coordinate system. Also in implementations, the radar data 124 may include signal strength information. For example, the signal strength information can indicate a type of the object. More specifically, radio waves may be reflected more strongly by objects having certain shapes and/or compositions. For example, broad, flat surfaces and/or sharp edges are more highly reflective than rounded surfaces, and metal is more highly reflective than a person. In some instances, the signal strength may include a radar cross-section (RCS) measurement. As also noted above, the radar data 124 may also include velocity information. For instance, a velocity of each of the points 116, 118 (and/or of the second vehicle 106) may be based on a frequency of radio energy reflected from the points 116, 118 and/or a time at which the reflected radio energy is detected.

Accordingly, the radar data 124 can include a distance of respective ones of the first points 116 from the first radar sensor 108 (e.g., a range or radial distance), a velocity (e.g., a Doppler velocity) of the respective one of the first points 116 along the distance, a strength measurement (e.g., an RCS value), and/or additional information. Similarly, the radar data 124 can also include a distance of respective ones of the second points 118 from the second radar sensor 110 (e.g., a range or radial distance), a velocity (e.g., a Doppler velocity) of the respective one of the second points 118 along the associated distance, strength information, and/or additional information.

In examples described in detail herein, the radar data 124 is used generally to track objects. More specifically, FIG. 1 illustrates that the vehicle 102 can include one or more vehicle computing device(s) 126 for executing functionality associated with the radar data 124. The vehicle computing device(s) 126 include a radar processing system 128 having an associated object representation generation component 130, as well as a track association component 132 and a track generation component 134. These systems and components are described in turn.

The radar processing system 128 generally implements functionality to receive the radar data 124 from the radar sensor(s) 108, 110 and generate object representations 136 of objects in an environment of the vehicle 102, such as representations of the second vehicle 106 and/or other dynamic and/or static objects in the environment. In examples, the radar processing system 128 may be a radar pipeline that processes only radar data, like the radar data 124, e.g., at the exclusion of sensor data 144 from other sensor modalities. The radar processing system 128 may include functionality to associate returns with each other and/or with specific objects. Thus, for example, the radar processing system 128 can determine that returns associated with the first points 116 and the second points 118 are associated with each other and/or with the second vehicle 106. The radar processing system 128 can also determine that other returns, e.g., in a same radar scan, are associated with other objects, for example, the road surface 104 proximate the second vehicle 106, other vehicles (not shown), or the like.

In some examples, the radar processing system can cluster points, e.g., the first points 116 and the second points 118, based on information from those returns. For instance, the first points 116 and the second points 118 are closely situated, e.g., within a threshold distance, and in some instances the radar processing component can determine that those points are indicative of a single object. In examples described herein, a point cluster may include a plurality of points that have some likelihood, e.g., a level and/or degree of similarity, to identify a single object or grouping of objects that should be considered together, e.g., by a planning system of the autonomous vehicle. In aspects of this disclosure, information in addition to position information may be used to determine the point cluster. For example, while the first points 116 and the second points 118 have similar positional returns, in some implementations other points that are also close in proximity can be excluded by the radar processing system 128, e.g., because such points may be representative of a different object. For instance, a signal strength, e.g., an RCS value, associated with one or more additional points (e.g., additional to the first points 116 and the second points 118) may be significantly different than the signal strength associated with the first points 116 and/or the second points 118, and thus the radar processing system 128 may exclude the additional point, even if the additional point is proximally close to the first points 116 and/or the second points 118. In a real-world example, if a person is standing next to a fire hydrant, the returns from the fire hydrant could have a significantly stronger signal, e.g., because the fire hydrant is metal, than the returns from the person.

The radar processing system 128 can use additional or different information to determine returns associated with objects. For example, when the radar sensor is a Doppler-type sensor, velocity of the objects may be used to determine the point cluster. In the illustrated example, points associated with the road surface 104 or with (not illustrated) other static objects in the environment will have significantly different velocities than the (moving) second vehicle 106. More specifically, because the road surface 104 is stationary and the second vehicle 106 is moving, points having a similar, non-zero velocity component can be clustered as being associated the second vehicle 106. Other information may also or alternatively be used to cluster points in accordance with the disclosure herein, and the examples provided are for illustration only. By way of non-limiting example, historical data of the object, e.g., of the second vehicle 106, can be used to determine whether points are associated with the object. For instance, if tracking data of an object provides historical position, velocity and/or acceleration data, the track association component 134 may expect more recent, e.g., contemporaneous, returns associated with the object to have values within some range.

The radar processing system 128 may be embodied as one or more data analysis structures, including one or more neural networks. Without limitation, the identification of points as being associated with the second vehicle 106 may be performed by one or more machine-learned networks. Without limitation, the radar processing system 128 may include one or more neural networks that process the radar data 124 to perform the grouping of points and association of points with objects just discussed. In at least some examples, the network can, for each return, identify an association of that point with one or more additional points, an association of that point with an object, classify the point (e.g., as being associated with a vehicle, a building, a pedestrian, or the like). In some instances, the radar processing system 128 can include some or all of the functionality described in U.S. patent application Ser. No. 16/587,605 for “Perception System,” filed on Sep. 30, 2019, the entirety of which is hereby incorporated by reference. Aspects of the system described in the '605 application include a top-down or two-dimensional machine learned radar perception update process in which a two-dimensional (or top-down) representation is generated from three-dimensional radar data.

The radar processing system 128 may also include the object representation generation component 130 configured to determine the object representation 136. More specifically, while the radar processing system 128 receives a plurality of radar points, e.g., from the radar sensors 108, 110, and/or other radar sensors, and makes some determination on a per-point basis, the object representation generation component 130 generates single representations of objects based on the per-point data. In the example of FIG. 1, the object representation generation component 130 generates a bounding box 138 as the object representation 136. The bounding box 138 is a two-dimensional representation of the second vehicle 106, generated by the object representation generation component 130 based on the first radar points 116, the second radar points 118, and/or other radar points, e.g., from other radar scans conducted by the first radar sensor 108, the second radar sensor 110, and/or other radar sensors. Although the bounding box 138 is illustrated as a two-dimensional bounding box, other instances of the object representation 136 can include other or different multi-dimensional representations, for example, a three-dimensional bounding box.

The object representation 136 can also include other attributes or characteristics of objects, such as the second vehicle 106, as determined from the radar data 124. Without limitation, the object representation 136 can include extents of the sensed object, e.g., embodied as the length, width, area, or the like, of the bounding box 138. The object representation can also include a position of the In FIG. 1, a position of the bounding box 138 may be coordinates associated with a point 140, which may represent a center of the bounding box 138. Although the point 140 is illustrated as being a center of the bounding box 138 the point may be other than the center. The object representation 136 can also include a velocity of the object. For instance, an arrow 142 in FIG. 1 indicates a velocity (e.g., direction and/or magnitude) associated with the bounding box 138. The object representation 136 can also include one or more of a classification of the object (e.g., a vehicle (as in FIG. 1), a pedestrian, a wheeled pedestrian, a bicyclist, a construction vehicle, an articulated vehicle, a building, or the like). The object representation may also include a probability or certainty associated with the representation. For example, the probability or certainty may be a single value associated with all attributes or with individual attributes (e.g. a probability/certainty associated with the classification determination, another associated with one or more dimensions of the bounding box, or the like).

The object representation 136 can be a singular representation of an object (the second vehicle 106 in FIG. 1) based on a plurality of radar points. The vehicle computing device(s) 126 can use the object representation 146 to track objects, such as the second vehicle 106. As used herein, “tracking an object” generally relates to predicting movement of an object, e.g., relative to the vehicle 102. In examples, the vehicle computing device(s) 126 may include functionality to generate and/or receive information about tracks of objects, e.g., as track information. As used herein, a track may generally describe attributes of a path of an object in the environment of the vehicle 102. In some examples, the track may be a series of measured and/or predicted poses or states of the object, e.g., relative to the vehicle 102. A track may include a series of multi-dimensional representations, e.g., two-dimensional bounding boxes, generated at a predetermined frequency to represent/predict movement of the object.

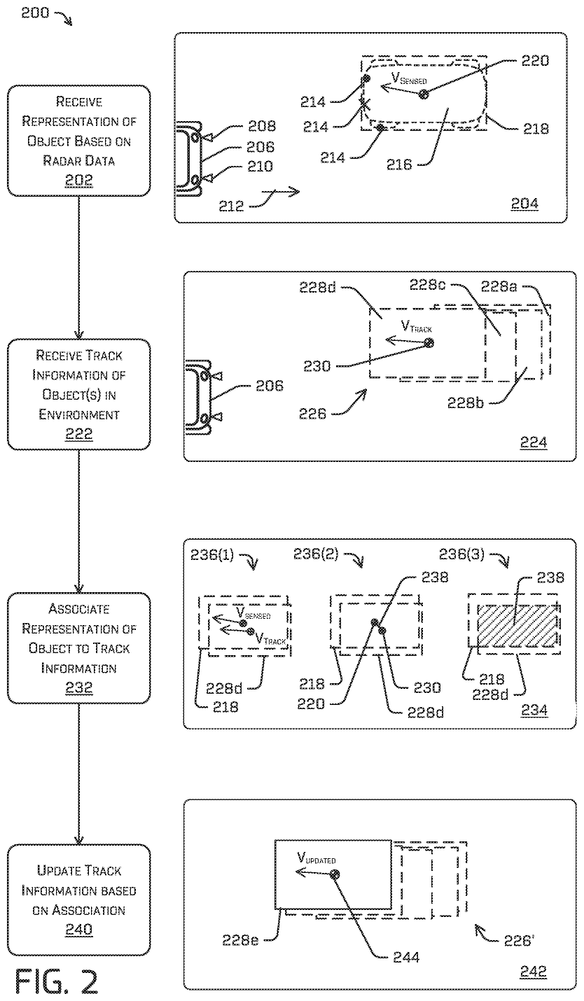

The track association component 132 includes functionality to determine whether the object representation 136 should be associated with an existing track, e.g., of a previously-sensed object. For example, the track association component can include functionality to compare the object representation 136 to track information. In the example of FIG. 1, the attributes of the representation of the second vehicle 106 discussed above, e.g., attributes of the bounding box 138, are compared to track information to determine whether the second vehicle 106 is already being tracked. As detailed further herein, particularly with reference to FIG. 2, below, the comparison of the object representation 136 to track information can include comparing a velocity of the object representation to a track velocity, a position of the object representation to a track position, or the like.

The track generation component 134 can include functionality to update a previously-generated track. For example, if the track association component 132 determines that the object representation 136 is associated with a track, e.g., the object representation 136 represents an object that is already being tracked, the track generation component 134 can update the track using the object representation 136, e.g., by predicting future movement of the second vehicle 106 using the object representation 136. In examples, the track generation component 134 can also receive additional data, e.g., sensor data 144 from the additional sensors 120. Without limitation, the track generation component 134 may fuse the object representation 136 with the sensor data 144 and/or other data to update the existing track of the second vehicle 106.

In other examples, the track generation component 134 can create a new track, e.g., in instances in which an object, like the second vehicle 106, is newly detected. For example, in instances in which an object representation 136 does not match an existing track, the track generation component 134 can use the object representation 136 to generate a new track. In some instances, the track generation component 134 can receive additional data, such as the sensor data 144, to generate a new track, e.g., using data from multiple sensor modalities. In at least some examples, the track generation component 134 can also, or alternatively, receive multiple instances of the object representation 136 to generate a new track. For example, multiple instances of the object representation 136, e.g., based on different radar scans and/or radar scans from different times. In examples described further herein, updated and/or new track information generated by the track generation component 134 may be used to control the vehicle 102, e.g., to navigate relative to tracked objects such as the second vehicle 106.

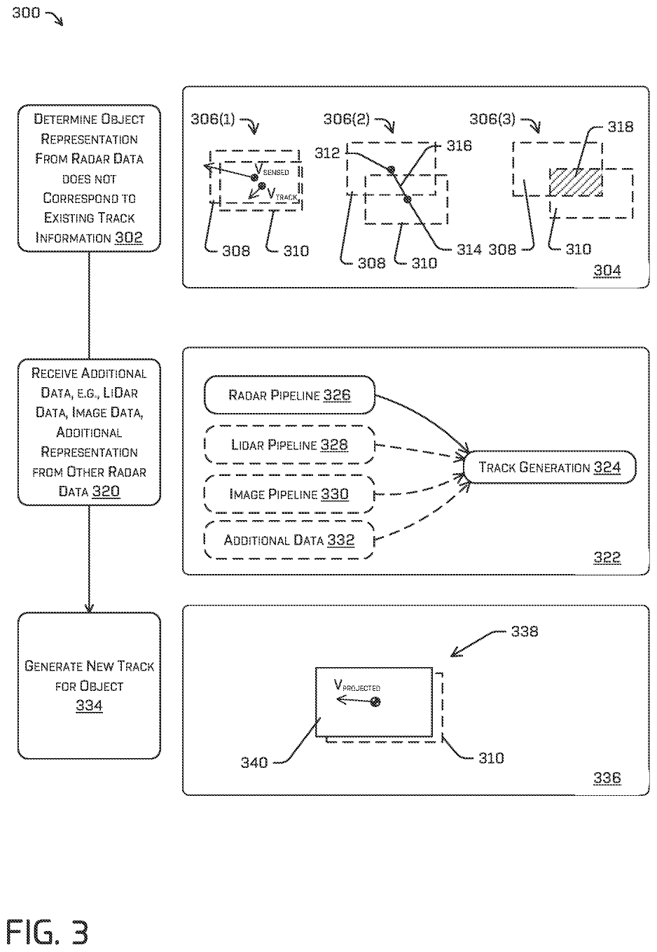

Techniques described herein may improve planning system accuracy and performance by determining and updating tracks of detected objects using radar data. For instance, radar sensors, like the radar sensors 108, 110 can be among the quickest sensors on some vehicles to generate meaningful amounts of data about objects, like the second vehicle 106. For example, the radar sensors 108, 110 may generate data about objects that are relatively farther away than can be detected by imaging sensors, LiDAR sensors, or the like. Moreover, radar sensors may be more reliable in low-light situations, e.g., at night, and/or during certain atmospheric conditions, e.g., during rainy weather, foggy weather, snowy weather, or the like. Conventionally, however, despite these benefits of radar sensors, radar data has not been used to track objects, at least in part because conventional techniques required point-by-point consideration of radar returns. Techniques described herein, however, generate the object representation 136 from a plurality of radar points, and use the object representation 136 for tracking the sensed object. As will be appreciated, comparing a single representation to track information is much less processing- and/or time-intensive than comparing dozens, or even hundreds, of points to track information. That is, the object representation 136 is a quickly-generated, and reliable, representation of the radar data 124. Moreover, as noted above, because radar sensors may detect objects at greater distance than other sensor modalities, the object representation 136 may promote earlier tracking of objects, thereby improving safety outcomes for the vehicle 102 as the vehicle 102 travels relative to the objects. Additional aspects of tracking objects using object representations from radar data will now be discussed with reference to FIGS. 2 and 3.

FIG. 2 includes textual and visual flowcharts to illustrate an example process 200 for updating track data using radar data. In examples described herein, the sensor data may be obtained by radar sensors disposed on an autonomous vehicle. In this example, the process 200 uses multiple radar sensors with overlapping fields of view to determine a representation of an object in the environment of the autonomous vehicle and then associates the object representation with track information associated with, e.g., previously generated for, the sensed object.

At an operation 202, the process 200 includes receiving a representation of an object based on radar data. An example 204 accompanying the operation 202 illustrates a vehicle 206 having a first radar sensor 208 and a second radar sensor 210 disposed on the vehicle 206. The first radar sensor 208 and the second radar sensor 210 may correspond to the radar sensors 108, 110. In the illustrated example, the vehicle 206 may be traversing through the environment generally in a direction indicated by an arrow 212 (although in other implementations, the vehicle 206 may be stationary or moving in a different direction), such that the first radar sensor 208 and the second radar sensor 210 are disposed on the leading end of the vehicle 206, e.g., to capture data about objects in front of the vehicle 206. In the examples, an object 216, which may be the second vehicle 106, is disposed generally in front of the vehicle 206. The first radar sensor 208 captures first radar data, e.g., via first radar scans, and the second radar sensor 210 captures second radar data, e.g., via second radar scans. In the illustrated embodiment, the first and second radar sensors 208, 210 are generally configured next to each other, both facing in the direction of travel, and with significant overlap in their fields of view.

In examples, the vehicle 206 may correspond to the vehicle 102, the first radar sensor 208 may correspond to the first radar sensor 108, and/or the second radar sensor 210 may correspond to the second radar sensor 110, shown in, and discussed in connection with, FIG. 1. The first radar sensor 208 and the second radar sensor 210 may be radar sensors that measure the range to objects and/or the velocity of objects. In some example systems, the radar sensors may be Doppler sensors, pulse-type sensors, continuous wave frequency modulation (CWFM) sensors, or the like. For example, the radar sensors 208, 210 may emit pulses of radio energy at predetermined intervals. In some implementations, the intervals may be configurable, e.g., to promote enhanced detection of objects at relatively far distances or relatively close distances. Moreover, the first radar sensor 208 and the second radar sensor 210 may have different ambiguous ranges, e.g., to facilitate disambiguation of otherwise-ambiguous returns.

The pulses of radio energy emitted from the first sensor 208 and the second sensor 210 can reflect off objects in the environment, and can be received by the radar sensors 208, 210, e.g., as radar data. In the example 204, the radar sensors may generate radar returns 214 associated with an object 216. The object 216 is embodied as another vehicle in the example 204, although it may be any of a number of objects.

The example 204 also illustrates a representation 218 of the object 216. The representation 218 can be a two-dimensional bounding box generally representing the extents of the object 216. As detailed herein, the representation 218 is generated from a plurality of radar returns, e.g., including the radar returns 214, from one or more radar scans. For instance, the radar processing system 128, illustrated in FIG. 1 and detailed above, may receive sensor data generated by the radar sensors 208, 210, and generate the representation 218 from that data. The representation 218 has an associated position, as designated by a point 220. The point 220 in the example 204 corresponds to the center of the bounding box that is the representation 218, although in other examples the point 220 may be other than the center. A position of the point 220 information indicative of a location of objects in the environment, e.g., a range and azimuth relative to the vehicle 206 or a position in a local or global coordinate system. The representation 218 also includes an associated velocity (v_{sensed}). Although not shown in the example 204, the representation 218 can include additional or alternative attributes, including but not limited to a classification of the sensed object (e.g., vehicle), a probability or certainty associated with one or more aspects of the representation 218, a signal strength metric, e.g. an RCS measurement, and/or other attributes. The representation 218 may be the object representation 136 in some examples.

At an operation 222, the process 200 includes receiving track information of object(s) in the environment. returns associated with an object from the radar data. An example 224 accompanying the operation 222 includes a visualization of a track 226 of an object in an environment of the vehicle 206. In this example, the track 226 is a series of tracked object representations 228a, 228b, 228c, 228d (collectively the tracked object representations 228). For example, the tracked object representations 228 may individually represent states of an object in the environment of the vehicle 206. In the example, the first tracked object representation 228a may be first in time, and the fourth tracked object representation 228d may be last in time. The tracked object representations 228 include associated information about the tracked object including, but not limited to, a position of the tracked object, e.g., indicated by a point 230, extents of the tracked object, e.g., indicated by the perimeter of the tracked object representations 228, a velocity of the tracked object, e.g., v_{track}, and/or other attributes. In the example 224, the point 230 corresponds to a center of the tracked object, although in other examples the point 230 may be other than the center. In still further instances, individual of the tracked object representations 228 may generated from different algorithms, based on different sensor data, and/or be otherwise distinguished.

One or more of the tracked object representations 228 can be predictions or expectations, of states of the tracked object (e.g., at some future point in time). For instance, the tracked object representations 228 may be generated based on sensor data related to the tracked object and/or one or more predictive models. The sensor data used to predict the state(s) of the tracked object can include the radar data 124 and/or the sensor data 144. Although the track 226 is visualized as four tracked object representations 228, the track 226 may include more or fewer observations. In at least one non-limiting example, the track 226 may include only a single representation, generally corresponding to a next-predicted state of the tracked object. Moreover, the tracked object representations 228 may have associated time information, e.g., a time at which the respective state represented by one of the tracked object representations 228 is to be achieved. The tracked object representations 228 can also include information associated with a classification of the tracked object (e.g., an automobile, a pedestrian, a bicycle, a motorcycle, or the like), probability, confidence, and/or certainty data associated with one or more aspects of the tracked object representations 228, or the like.

Although the example 224 shows only a single track 226, in other examples the track information will include a plurality of tracks, e.g., each associated with a different tracked object. As will be appreciated, in some settings, the autonomous vehicle 206 may navigate relative to several cars, pedestrians, bicyclists, skateboarders, and/or other dynamic objects. The track information received at the operation 222 may include a track for each dynamic object.

At an operation 232, the process 200 includes associating the representation of the object to the track information. For example, the operation 232 includes comparing the representation 218 with the track 226 and/or any other tracks in the track information, to determine whether the sensed object corresponds to an already-being-tracked object. An example 234 accompanying the operation 232 illustrates techniques for implementing the operation 232. More specifically, the example 234 includes a first comparison example 236(1), a second comparison example 236(2), and a third comparison example 236(3) (collectively, “the comparison examples 236”).

The first comparison example 236(1) illustrates a process for comparing velocities to determine whether a sensed object corresponds to a tracked object. More specifically, the first comparison example 236(1) shows both the representation 218 of the radar data from the radar sensors 208, 210 and the fourth tracked object representation 228d. In this example, the fourth tracked representation 228d may be the one of the tracked object representations 228 that is closest in time to a time associated with the radar data, e.g., a time at which the radar data is generated, a time at which the radar data is received at the radar sensors 208, 210, or the like. In other examples, the fourth tracked representation 218 may also or alternatively be selected because it is most-recently generated (or only) tracked object representation. Other criteria may also or alternatively be used to select the tracked object representation for comparison to the sensed object representation 218.

As illustrated in the first comparison example 236(1), and as discussed above, the representation 218 is a singular representation of a sensed object, generated from a plurality of radar returns associated with that object. The representation 218 also has an associated velocity, v_{sensed}, based at least in part on the velocities of the represented radar returns. Similarly, the tracked object representation 228d has an associated track velocity, v_{track}. In the first comparison example 236(1), the sensed velocity and the track velocity are compared, and if a difference between the sensed velocity and the track velocity is equal to or less than a threshold velocity, the representation 218 is associated with the tracked object representation 228d, and thus the track 226. Stated differently, if the sensed velocity of the representation 218 is the same as, or within a threshold difference of, the (expected) velocity of an object being tracked, the sensed object can be associated with the track.

The second comparison example 236(2) illustrates a process for comparing positions to determine whether a sensed object corresponds to a tracked object. As with the first comparison example 236(1), the second comparison example 236(2) shows both the representation 218 of the radar data from the radar sensors 208, 210 and the fourth tracked object representation 228d. Also, as with the previous example, the fourth tracked representation 228d may be selected based on any number of criteria. The representation 218 also includes the point 220, e.g., the center of the representation 218, and the fourth tracked object representation 228d includes the point 230, e.g., the center of the fourth tracked representation 228d. In the second comparison example 236(2), a distance, represented by a line 238, is a distance between the point 220 and the point 230. The operation 232 includes associating the representation 218 with the tracked object representation 228d, and thus with the track 226 and the object being tracked thereby, when the distance is equal to or below a threshold distance. Stated differently, if the position of the representation 218 is within a threshold distance of the (expected) position of an object being tracked, the sensed object can be associated with the track.

The third comparison example 236(3) illustrates a process for comparing areas to determine whether a sensed object corresponds to a tracked object. As with the first comparison example 236(1) and the second comparison example 236(2), the third comparison example 236(3) shows both the representation 218 of the radar data from the radar sensors 208, 210 and the fourth tracked object representation 228d. Also as with the previous examples, the fourth tracked representation 228d may be selected based on any number of criteria. The representation 218 is a two-dimensional bounding box, e.g., having a length and width, generally representing a length and width of the object 216, and the fourth tracked object representation 228d is a two-dimensional representation e.g., having a length and width. In the third comparison example 236(3), an area of overlap 240 is an area shared by the representation 218 and the fourth tracked object representation 228d. In this example, the representation 218 and the fourth tracked object representation 228d is equal to or greater than a threshold area. In other examples, the respective areas of the representation 218 and the fourth tracked object representation 228d may be used to detect an intersection over union (IOU), e.g., the ratio of the area of overlap 240 to a total area of the representations. The operation 232 can include associating the representation 218 with the tracked object representation 228d, and thus with the track 226 and the object being tracked thereby, when the value of the IOU is equal to or greater than a threshold value. Stated differently, if there is sufficient overlap of the representation 218 with an object being tracked, the sensed object can be associated with the track.

In instances, one, two, or all three of the comparison examples 236 may be used to associate a sensed object with a tracked object. Moreover, as discussed below, other or additional example techniques may be used. However, in some instances, it may be desirable to first perform the first comparison example 236(1). Specifically, radar data will provide a reliable (e.g., accurate) velocity determination, so the velocity comparison may accurately determine the association.

The comparison examples 236 are for illustration only, and as will be appreciated from the following description, those having ordinary skill, with the benefit of this disclosure, may appreciate other techniques for comparing the representation 218 with the track information. Without limitation, the comparison may include comparing a classification associated with each of the representations. In still further examples, the comparison may be determined based at least in part on a confidence associated with one or both of the representation 218 and the track representations 228. Without limitation, and using the first comparison example 236(1) for illustration, the sensed velocity and/or the track velocity may have an associated uncertainty, which in some examples may be determined by a processing system or algorithm that determines those values. For example, the radar processing system 128 may include functionality to determine the sensed velocity (and/or other attributes included in the object representations 136) from the radar data 124, generally as discussed above, as well as functionality to determine a certainty of that velocity. In implementations, for example, the uncertainty may be used to actively adjust the velocity threshold that will result in association of the representation 218 of the radar data with the track 226 or a portion thereof.

The process 200 also includes, at an operation 242, updating the track information based on the association. For example, when, at the operation 232, the representation 218 is determined to be associated with the track 226, the representation 218 can be used to update the track 226. An example 244 accompanying the operation 242 illustrates an updated track 226′ that has been updated to include a fifth tracked object representation 228e. In the example 244, the fifth tracked object representation 228e includes a point 246 representing a position of the representation 228e and a velocity, V_{updated}. The updated track 226′ is illustrated for example only, as more than a single tracked object representation may be generated based at least in part on the representation 218. Without limitation, a plurality of tracked object representations may be generated based at least in part on the representation 218, with individual of the tracked representations being associated with a different time, being based on a different prediction model, being generated from certain types of data, or the like. In at least some examples, the representation 218 may be fused with one or more additional data types, models, or the like, to generate the updated track 226′.

From the foregoing description of FIG. 2, the process 200 can be used to update track information based on the representation 218, generated from radar data. In contrast, conventional techniques required a point-by-point (or return-by-return) comparison of radar data to track information to associate those points with tracks, which is particularly time and processing intensive, often rendering tracking using radar data undesirable. The representation is a single representation of a plurality of radar points, so the process 200 requires far fewer processes to determine an association. For instance, even if more than one of the techniques described above in connection with the comparison examples 236 is used to confirm an association, the process 200 facilitates the use of radar data for tracking.

FIG. 3 includes textual and visual flowcharts to illustrate an example process 300 for generating anew track for association with an object detected using radar data. In examples described herein, the radar data may be obtained by radar sensors disposed on an autonomous vehicle. In this example, the process 300 uses a representation of an object in the environment of the autonomous vehicle to determine that the object is not yet being tracked, and generates new track information for the object.

At an operation 302, the process 300 includes determining that an object representation from radar data does not correspond to existing track information. For example, the operation 302 can include comparing a sensed object representation with one or more tracked object representations and determined, based on the comparison, that the An example 304 accompanying the operation 302 includes a first comparison example 306(1), a second comparison example 306(2), and a third comparison example 306(3) in which an object representation does not correspond to existing track information.

The first comparison example 306(1) shows a sensed object representation 308 generated from radar data. For instance, the sensed object representation may be a single representation of a plurality of radar returns, e.g., from one or more radar scans. The sensed object representation 308 may be the object representation 136 and/or the representation 218 in some examples. The object representation 308 has an associated sensed object velocity, v_{sensed}. The first comparison example 306(1) also shows a tracked object representation 310. The tracked object representation may be associated with a track, like the track 226, and may represent expected or predicted attributes of an object being tracked, e.g., a tracked object. In some examples, the tracked object representation 310 can correspond to one of the tracked object representations 228. As also illustrated in FIG. 3, the tracked object representation 310 has an associated tracked object velocity, v_{track}. The operation 302, in the first comparison example 306(1), includes comparing the sensed object velocity and the tracked object velocity and, based on the comparison, determining that the sensed object representation 308 does not correspond to the tracked object representation 310. In the example, the magnitude and/or direction of the sensed object velocity and the tracked object velocity may be sufficiently different, e.g., greater than a threshold difference, that the sensed object is determined to be other than the tracked object. Accordingly, unlike in the process 200, the sensed object represented by the sensed object representation 308 is not associated with a track of which the tracked object representation 310 is a part.

The second comparison example 306(2) also includes the sensed object representation 308 and the tracked object representation 310. In this example, the sensed object representation 308 also has a position, represented by a point 312, and the tracked object representation 310 has a position represented by a point 314. Although the points 312, 314 are shown as the centers of the respective representations 308, 310, the points may be other than centers. In this example, the points 312, 314 are separated by a distance represented by the line 316. In this example, the line 316 has a length greater than a threshold length. Thus, in the second comparison example 306(2), the sensed object representation 308 is sufficiently far away from an expected position of a tracked object that the sensed object is determined to not correspond to the tracked object. Accordingly, unlike in the process 200, the sensed object represented by the sensed object representation 308 is not associated with a track of which the tracked object representation 310 is a part.

The third comparison example 306(2) also includes the sensed object representation 308 and the tracked object representation 310. In this example, the sensed object representation 308 is a two-dimensional representation of the sensed object, e.g., a two-dimensional bounding box having a length and a width. The tracked object representation 310 is also a two-dimensional representation, e.g., an expected or predicted bounding box of a tracked object. The example 304 also illustrates an area of overlap 318 representing a portion of the area of the sensed object representation 308 that overlaps with the tracked object representation 310. In the third comparison example 306(3), the area of overlap 318 is used to determine that the sensed object is not associated with the track. For instance, if the area of overlap 318 is below a threshold value, e.g., if the value is equal to or close to zero, the operation 302 can determine that the sensed object is not associated with the tracked object. In another example, an intersection over union (IOU) may be calculated for the sensed object representation 308 and the tracked object representation 310, and, if the IOU is below a threshold value, the operation 302 will determine that the sensed object is not associated with the tracked object.

The techniques used in the comparison examples 306 generally correspond to the techniques used in the comparison examples 236 discussed above, respectively. However, the comparison examples 236 found an association between the representations 218, 228d, whereas the comparison examples 306 found no association. Other techniques, including those discussed above in connection with the comparison examples 236, may alternatively or additionally be implemented by the operation 302.

Although the example 304 illustrates a comparison of the sensed object representation 308 to only the tracked object representation 310, the operation 302 may include comparing the sensed object representation to any number of tracks and/or tracked object representations. In one example, if the sensed object representation 308 is associated with a vehicle, the operation 302 can include comparing the sensed object representation 308 to tracked object representations for all vehicles being tracked.

At an operation 320, the process 300 includes receiving additional data. For example, the additional data can include lidar data, image data, and/or one or more additional representations generated from radar data. An example 322 accompanying the operation 320 depicts a track generation component 324 receiving data from a radar pipeline 326, and, optionally, from one or more of a lidar pipeline 328, an image pipeline 330, and/or an additional data source 332. In this example, the radar pipeline 326 can represent a processing system that primarily processes radar data, the lidar pipeline 328 can represent a processing system the primarily processes lidar data, and/or the image pipeline 330 can represent a processing system that primarily processes image data. The additional data source 332 can represent one or more processing systems that process other types of data and/or that process multiple types of data. For example, and without limitation, the radar pipeline 326 can correspond to the radar processing system 128. As detailed above, the radar processing system 128 receives radar data from radar sensors and generates the object representations 136 based thereon. In some examples, the track generation component 324 can identify objects from data and/or information from any of the example sources (and/or other sources). For example, when the sensed object representation 308 corresponds to a pedestrian, track generation component can identify lidar data, image data, and/or other data also associated with the pedestrian. In some instances, the track generation component 324 can correspond to the track generation component 134 discussed above.

At an operation 334, the process 300 includes generating a new track for the sensed object. For example, the track generation component 324 can generate a new track, as described herein. An example 336 accompanying the operation 334 illustrates a track 338. More specifically, the track 338 is illustrated as a series (two in the example 336) of representations, including the object representation 308 and a tracked object representation 340 generated by the track generation component 324 based at least in part on the object representation 308. The tracked object representation 340 is a two-dimensional representation of the sensed object, having a position indicated by a point 342 and a velocity, v_{projected}. As detailed herein, the tracked object representation may include additional or different data in some instances.

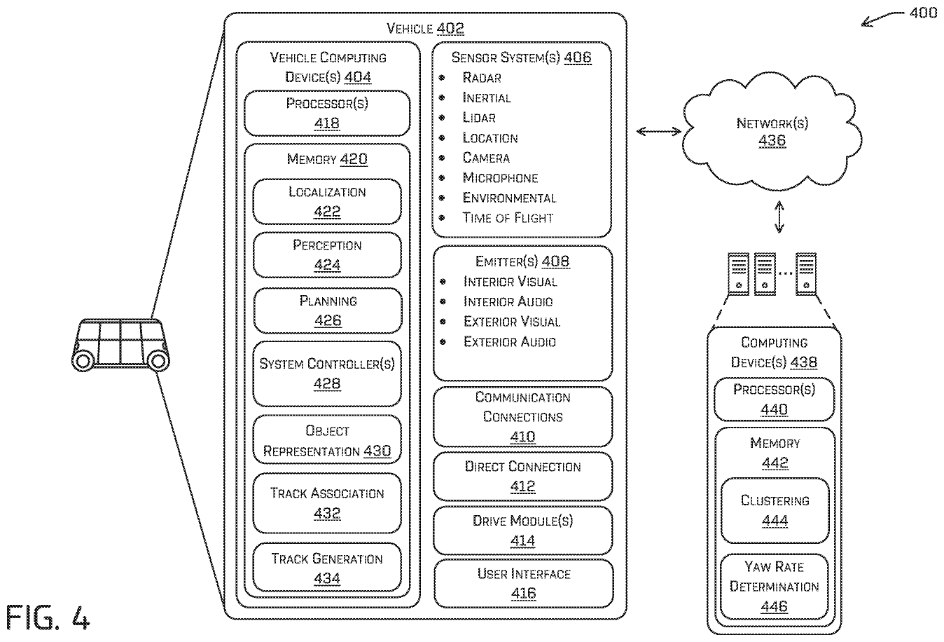

FIG. 4 is a block diagram of an example system 400 for implementing the techniques described herein. In at least one example, the system 400 can include a vehicle 402, which can be the same vehicle as the vehicle 102, the vehicle 206, and/or the vehicle 306 described above with reference to FIGS. 1, 2, and 3, respectively.

The vehicle 402 can include one or more vehicle computing devices 404, one or more sensor systems 406, one or more emitters 408, one or more communication connections 410, at least one direct connection 412, one or more drive modules 414, and a user interface 416.

The vehicle computing device(s) 404 can include one or more processors 418 and memory 420 communicatively coupled with the one or more processors 418. In the illustrated example, the vehicle 402 is an autonomous vehicle; however, the vehicle 402 could be any other type of vehicle. In the illustrated example, the memory 420 of the vehicle computing device 404 stores a localization component 422, a perception component 424, a planning component 426, one or more system controllers 428, a radar processing system 430, a track association component 432, and a track generation component 434. Though depicted in FIG. 4 as residing in the memory 420 for illustrative purposes, it is contemplated that the localization component 422, the perception component 424, the planning component 426, the one or more system controllers 428, the radar processing system 430, the track association component 432, and/or the track generation component 434 can additionally, or alternatively, be accessible to the vehicle 402 (e.g., stored on, or otherwise accessible by, memory remote from the vehicle 402).

In at least one example, the localization component 422 can include functionality to receive data from the sensor system(s) 406 to determine a position and/or orientation of the vehicle 402 (e.g., one or more of an x-, y-, z-position, roll, pitch, or yaw). For example, the localization component 422 can include and/or request/receive a map of an environment and can continuously determine a location and/or orientation of the autonomous vehicle within the map. In some instances, the localization component 422 can utilize SLAM (simultaneous localization and mapping), calibration, localization and mapping, simultaneously techniques, relative SLAM, bundle adjustment, non-linear least squares optimization, or the like to receive image data, LiDAR data, radar data, IMU data, GPS data, wheel encoder data, and the like to accurately determine a location of the autonomous vehicle. In some instances, the localization component 422 can provide data to various components of the vehicle 402 to determine an initial position of an autonomous vehicle for generating a candidate trajectory, as discussed herein.

In some instances, the perception component 424 can include functionality to perform object detection, segmentation, and/or classification. In some examples, the perception component 424 can provide processed sensor data that indicates a presence of an entity that is proximate to the vehicle 402 and/or a classification of the entity as an entity type (e.g., car, pedestrian, cyclist, animal, building, tree, road surface, curb, sidewalk, unknown, etc.). In additional and/or alternative examples, the perception component 424 can provide processed sensor data that indicates one or more characteristics associated with a detected entity and/or the environment in which the entity is positioned. In some examples, characteristics associated with an entity can include, but are not limited to, an x-position (global position), a y-position (global position), a z-position (global position), an orientation (e.g., a roll, pitch, yaw), an entity type (e.g., a classification), a velocity of the entity, an acceleration of the entity, an extent of the entity (size), etc. Characteristics associated with the environment can include, but are not limited to, a presence of another entity in the environment, a state of another entity in the environment, a time of day, a day of a week, a season, a weather condition, an indication of darkness/light, etc. By way of non-limiting example, the perception component 424 may generate the object representations 136, 218 from radar data, as discussed herein.

The planning component 426 can determine a path for the vehicle 402 to follow to traverse through an environment. The planning component 426 can determine various routes and trajectories and various levels of detail. For example, the planning component 426 can determine a route to travel from a first location (e.g., a current location) to a second location (e.g., a target location). For the purpose of this discussion, a route can be a sequence of waypoints for travelling between two locations. As non-limiting examples, waypoints include streets, intersections, global positioning system (GPS) coordinates, etc. Further, the planning component 426 can generate an instruction for guiding the autonomous vehicle along at least a portion of the route from the first location to the second location. In at least one example, the planning component 426 can determine how to guide the autonomous vehicle from a first waypoint in the sequence of waypoints to a second waypoint in the sequence of waypoints. In some examples, the instruction can be a trajectory, or a portion of a trajectory. In some examples, multiple trajectories can be substantially simultaneously generated (e.g., within technical tolerances) in accordance with a receding horizon technique, wherein one of the multiple trajectories is selected for the vehicle 402 to navigate.

In at least one example, the vehicle computing device 404 can include one or more system controllers 428, which can be configured to control steering, propulsion, braking, safety, emitters, communication, and other systems of the vehicle 402. These system controller(s) 428 can communicate with and/or control corresponding systems of the drive module(s) 414 and/or other components of the vehicle 402.

The radar processing system 430 can be the radar processing system 128 detailed above. Generally, the radar processing system 430 can include functionality to receive radar data and generate representations of objects from the radar data, e.g., as the object representations 136. For example, the radar processing system 430 may receive sensor data comprising a plurality of points and information associated with the points, including position information, signal strength information, velocity information, or the like about points. The radar processing system 430 may employ one or more processing models, algorithms, or the like, to the received sensor data to determine object representations such as the object representation 136. Each of the object representations may be a single representation generated from a plurality of radar points associated with the same, sensed object. Stated differently, the radar processing system 430 generates single representations of objects based on radar data deemed to be associated with those objects. The sensed object representations may be multi-dimensional, e.g., two- or three-dimensional bounding boxes, with associated attributes of the sensed object including but not limited to a velocity, position, classification, and/or other aspects of the sensed object's pose or state. Moreover, the radar processing system 430 can generate one or more probabilities, confidence values, and/or the like associated with the object representations 136 and/or aspects or attributes of the object representations 136.

The track association component 432 can be the track association component 132. The track association component 432 generally includes functionality to associate sensed object representations, e.g., generated from radar data, with track information for objects already being tracked. For instance, the track association component 432 can include functionality to compare aspects of a sensed object representation, e.g., one of the object representations 136, with tracked object representations, which may be part of a track. The example 234 of FIG. 2 demonstrates example functionality of the track association component 432.

The track generation component 434 can be the track generation component 134 and/or the track generation component 324. The track generation component 324 generally includes functionality to receive object representations from radar data, like the object representations 136, and update existing tracks or create new tracks based thereon. For instance, when the track association component 432 determines that a sensed object is associated with an existing track, the track generation component can generate updated track information, e.g., for appending or updating the existing track. In other examples, when an object representation associated with a sensed object does not correspond to an existing track, e.g., based on a comparison of the representation to the track information, the track generation component 324 generates a new track, e.g., like the track 338, for association with the sensed object.

Although shown separate from other components for clarity and ease of reference, functionality of the radar processing system 430, the track association component 432, and/or the track generation component 434 may be performed by other aspects of the vehicle 402. Without limitation, one or more of those components may be incorporated into the perception system 424. Aspects of this disclosure provide improved functionality resulting at least in part from use of a singular representation of a plurality of radar returns, regardless of the module, component, or system using that data according to the techniques detailed herein.

In at least one example, the sensor system(s) 406 can include the radar sensors described herein. Also in examples, the sensor system(s) 406 can include LiDAR sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 406 can include multiple instances of each of these or other types of sensors. For instance, and as discussed herein, implementations of this disclosure may use multiple scans from multiple sensors, e.g., multiple radar sensors, with overlapping fields of view. Thus, for example, the autonomous vehicle 402 may include a number of radar sensors. In additional examples, the LiDAR sensors can include individual LiDAR sensors located at the corners, front, back, sides, and/or top of the vehicle 402. As another example, the camera sensors can include multiple cameras disposed at various locations about the exterior and/or interior of the vehicle 402. The sensor system(s) 406 can provide input to the vehicle computing device 404. Additionally, or alternatively, the sensor system(s) 406 can send sensor data, via the one or more networks 436, to the one or more computing device(s) at a particular frequency, after a lapse of a predetermined period of time, in near real-time, etc.

The emitter(s) 408 may be configured to emit light and/or sound. The emitter(s) 408 in this example include interior audio and visual emitters to communicate with passengers of the vehicle 402. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. In some examples, one or more of the interior emitters may be used to signal to the passenger that the vehicle is approaching or has arrived at an unmapped region and that continued movement in the unmapped region will require permission and/or manual control. In addition, or alternatively, the interior emitters may alert the passenger(s) that a teleoperator or other external source (e.g., a passenger-in-waiting) has taken manual control of the vehicle 402. The emitter(s) 408 in this example can also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The communication connection(s) 410 can enable communication between the vehicle 402 and one or more other local or remote computing device(s). For instance, the communication connection(s) 410 can facilitate communication with other local computing device(s) on the vehicle 402 and/or the drive module(s) 414. Also, the communication connection(s) 410 can allow the vehicle to communicate with other nearby computing device(s) (e.g., other nearby vehicles, traffic signals, etc.). The communications connection(s) 410 also enable the vehicle 402 to communicate with a remote teleoperations computing device or other remote controllers.

The communications connection(s) 410 can include physical and/or logical interfaces for connecting the vehicle computing device 404 to another computing device or a network, such as network(s) 436. For example, the communications connection(s) 410 can enable Wi-Fi-based communication such as via frequencies defined by the IEEE 802.11 standards, short range wireless frequencies such as Bluetooth®, cellular communication (e.g., 2G, 4G, 4G, 4G LTE, 5G, etc.) or any suitable wired or wireless communications protocol that enables the respective computing device to interface with the other computing device(s).

In at least one example, the vehicle 402 can include the drive module(s) 414. In some examples, the vehicle 402 can have a single drive module 414. In at least one example, if the vehicle 402 has multiple drive modules 414, individual drive modules 414 can be positioned on opposite ends of the vehicle 402 (e.g., the front and the rear, etc.). In at least one example, the drive module(s) 414 can include one or more sensor systems to detect conditions of the drive module(s) 414 and/or the surroundings of the vehicle 402. By way of example and not limitation, the sensor system(s) can include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, LiDAR sensors, radar sensors, etc. Some sensors, such as the wheel encoders can be unique to the drive module(s) 414. In some cases, the sensor system(s) 406 on the drive module(s) 414 can overlap or supplement corresponding systems of the vehicle 402 (e.g., the sensor system(s) 406).

The drive module(s) 414 can include many vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive module(s) 414 can include a drive module controller which can receive and preprocess data from the sensor system(s) 406 and to control operation of the various vehicle systems. In some examples, the drive module controller can include one or more processors and memory communicatively coupled with the one or more processors. The memory can store one or more modules to perform various functionalities of the drive module(s) 414. Furthermore, the drive module(s) 414 also include one or more communication connection(s) that enable communication by the respective drive module with one or more other local or remote computing device(s).

In at least one example, the direct connection 412 can provide a physical interface to couple the one or more drive module(s) 414 with the body of the vehicle 402. For example, the direction connection 412 can allow the transfer of energy, fluids, air, data, etc. between the drive module(s) 414 and the vehicle. In some instances, the direct connection 412 can further releasably secure the drive module(s) 414 to the body of the vehicle 402.

The user interface 416 may include one or more devices, buttons and/or control panels via which a passenger can communicate with the vehicle 402. In non-limiting examples, a passenger in the vehicle 402 may control functionality of the vehicle 402 via interaction(s) with the user interface 416. In other examples, the user interface 416 may comprise a microphone configured to receive a verbal or spoken input. Generally, the user interface 416 may provide a means though which a passenger can interface with the vehicle computing device(s) 404.

In at least one example, the vehicle 402 may be in communication, via one or more network(s) 436, with one or more computing device(s) 438. For example, as described herein, the vehicle 402 can communicate with the one or more computing device(s) 438 via the network(s) 436. In some examples, the vehicle 402 can receive control signals from the computing device(s) 438. In other examples, the vehicle 402 can transmit information to the computing device(s) 438.

The computing device(s) 438 may be embodied as a fleet management system. In at least one example, the computing device(s) 438 can include processor(s) 440 and memory 442 communicatively coupled with the processor(s) 440. In the illustrated example, the memory 442 of the computing device(s) 438 stores a track association component 444 and a track generation component 446. In at least one example, the track association component 444 can correspond to at least a portion of the track association component 432. Moreover, the track generation component 446 can correspond to at least a portion of the track generation component 434.

In some instances, aspects of some or all of the components discussed herein can include any models, algorithms, and/or machine learning algorithms. For example, in some instances, aspects of the components in the memory 420, 442 can be implemented as a neural network.

As described herein, an exemplary neural network is a biologically inspired algorithm which passes input data through a series of connected layers to produce an output. Each layer in a neural network can also comprise another neural network, or can comprise any number of layers (whether convolutional or not). As can be understood in the context of this disclosure, a neural network can use machine learning, which can refer to a broad class of such algorithms in which an output is generated based on learned parameters.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

Additional examples of architectures include neural networks such as ResNet50, ResNet101, VGG, DenseNet, PointNet, and the like.

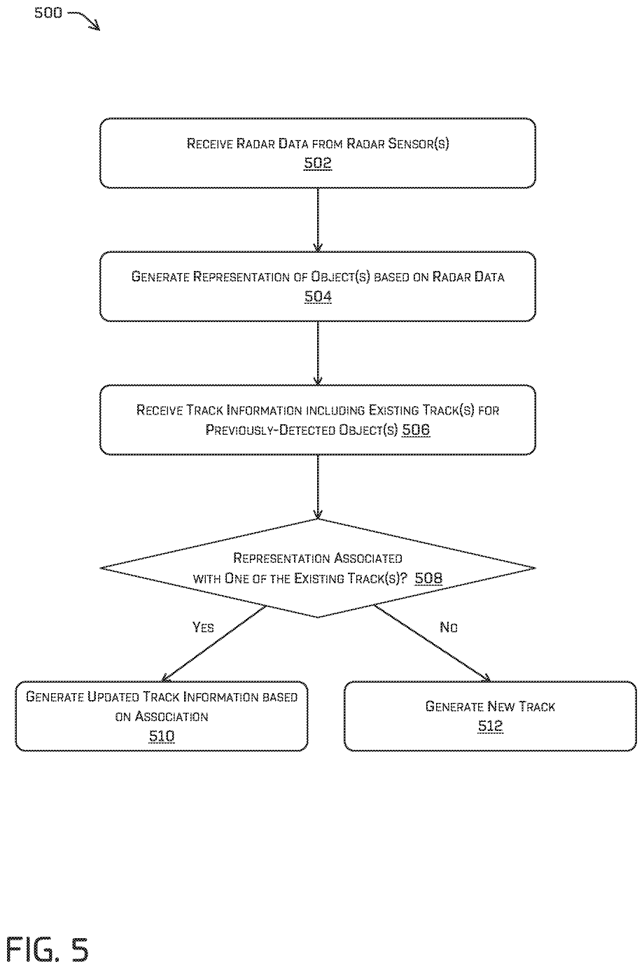

FIGS. 5-7 (as well as FIGS. 2 and 3 discussed above) illustrate example processes in accordance with embodiments of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 5 depicts an example process 500 for tracking objects using sensor data, such as radar data from multiple radar scans. For example, some or all of the process 500 can be performed by one or more components in FIG. 4, as described herein. Without limitation, some or all of the process 500 can be performed by the radar processing system 420, the track association component 432, and/or the track generation component 434.

At an operation 502, the process 500 includes receiving radar data from one or more radar sensors. As described above, the vehicle 102 includes the first and second radar sensors 108, 110, the vehicle 206 includes the first and second radar sensors 208, 210, and the vehicle 402 can include sensor system(s) 406 including a plurality of radar sensors having overlapping fields of view, e.g., to receive radar returns associated with the same objects in an environment of the vehicle 402. The radar data can include one or more of position information of objects in an environment of the vehicle 402, e.g., a range and direction, velocity information (e.g., a doppler velocity) for the objects, signal strength (e.g., an RCS measurement), or the like.

At an operation 504, the process 500 includes generating a representation of one or more objects based on the radar data. For example, the vehicle 102 includes the radar processing system 128 and the vehicle 402 includes the radar processing system 430. The radar processing systems 128, 430 include functionality to identify, from the radar data received at the operation 502, sensed objects. In some examples, the radar processing systems 128, 430 can include one or more trained machine learning models and/or other data processing models that receive the radar data as an input and outputs one or more representations of objects in the sensor data. Without limitation, the output may be one of the object representations 136, the object representation 218, and/or the sensed object representation 308. As detailed herein, the object representation is a single representation, e.g., a bounding box of a sensed object, of a plurality of radar returns associated with that sensed object.

At an operation 506, the process 500 includes receiving track information including one or more existing tracks for one or more previously-detected objects. In implementations described herein, a vehicle is controlled to navigate relative to one or more objects in an environment. The vehicle can include functionality to determine, e.g., predict, movement of dynamic objects in the environment. Such predictions may be embodied as tracks associated with those detected objects.

At an operation 508, the process 500 includes determining whether the representation is associated with one of the existing track(s). For instance, the operation 508 can compare the sensed object representation to the track(s) and determine whether the sensed object represented by the representation generated at the operation 504 is already being tracked. The example 234 of FIG. 2 and the example 304 of FIG. 3, both discussed above, illustrate example techniques for determining whether representations are associated with existing tracks. More specifically, the example 234 provides examples in which the representation is associated with a track and the example 304 provides examples in which the representation is not associated with a track. In examples, the operation 508 may be performed relative to each existing track, e.g., by comparing a representation of radar data to each existing track. In other examples, the representation may be compared only to existing tracks having some similarity, e.g., based on location, classification, or the like.

If, at the operation 508, it is determined that the representation is associated with one of the existing track(s), at an operation 510 the process 500 includes generating updated track information based on the representation. In examples described herein, once the representation based on the radar data is confirmed to be a representation of an object already being tracked, the track may be updated using the representation. As detailed herein, techniques according to this disclosure facilitate the use of radar data in tracking objects by obviating the need for per-point consideration of the returns, thereby reducing time and processing requirements that have caused conventional tracking techniques to avoid using radar data.

Alternatively, if at the operation 508 it is determined that the representation is not associated with one of the existing track(s), at an operation 512 the process 500 includes generating a new track. In examples described herein, if a representation of a sensed object generated from radar data does not correspond to an existing track, the sensed object is not already being tracked. Accordingly, the operation 512, which may be implemented by the track generation component 134, 444 can generate a new track. In some examples, the operation 512 can correspond to the operation 334. In examples described herein, a radar sensor may be among the first sensors on an automobile to detect objects. The techniques described herein can leverage this earlier detection by not only generating a representation of the sensed object, but also leveraging the representation to generate a new track for the sensed object.

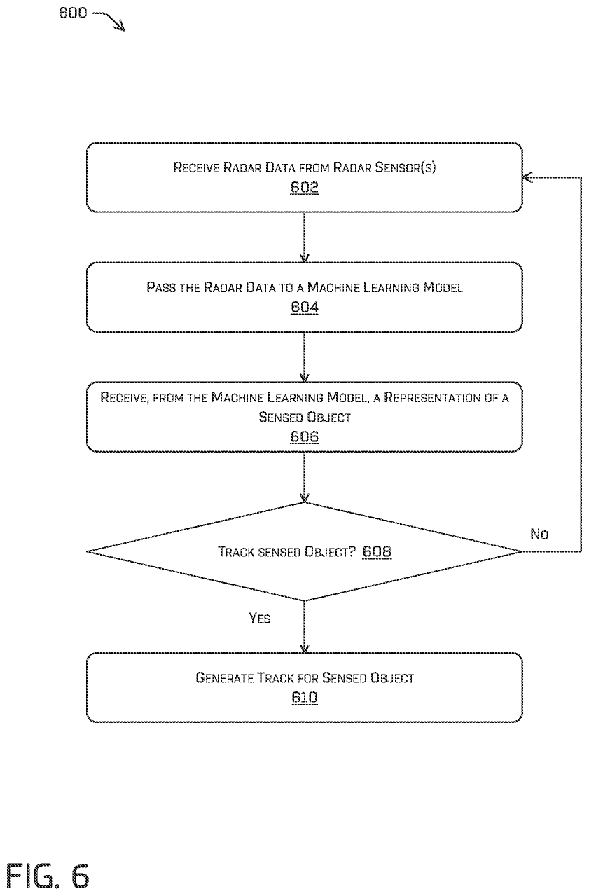

FIG. 6 depicts an example process 600 for generating a new track for a sensed object newly-detected in radar data. For example, some or all of the process 600 can be performed by one or more components in FIG. 4 described herein. Without limitation, some or all of the process 600 can be performed by the radar processing system 420, the track association component 432, and/or the track generation component 434.

At an operation 602, the process 600 includes receiving radar data from one or more radar sensors. As described above, the vehicle 102 includes the first and second radar sensors 108, 110, the vehicle 206 includes the first and second radar sensors 208, 210, and the vehicle 402 can include sensor system(s) 406 including a plurality of radar sensors having overlapping fields of view, e.g., to receive radar returns associated with the same objects in an environment of the vehicle 402. The radar data can include one or more of position information of objects in an environment of the vehicle 402, e.g., a range and direction, velocity information (e.g., a doppler velocity) for the objects, signal strength (e.g., an RCS measurement), or the like. In some instances, the radar data may be a point cloud, comprising a plurality of returns from a same radar scan or a plurality of radar scans. the radar returns can be represented as a point cloud and the point cloud can be passed into a machine-learned model.

At an operation 604, the process 600 includes passing the radar data to a machine learning model. For example, the radar processing system 128 can include one or more radar data processing algorithms including one or more convolutional neural networks and/or deep neural networks. In some examples, the machine learning model may be trained to output semantic information and/or state information by reviewing data logs to identify sensor data, e.g., subsets of the radar data, representing objects in an environment. Without limitation, the model may be trained on training data comprising ground truth information associated with object(s). As noted above, the radar data may be embodied as a point cloud passed to the machine learning model. In at least some examples, the point cloud can be passed to the same layer of the machine learned model, such that the machine learned model processes the plurality of radar returns, e.g., the point cloud, simultaneously.

At an operation 606, the process 600 includes receiving, from the machine learning model, a representation of a sensed object. For example, the representation may be the object representation 136 and/or may be a multi-dimensional representation, e.g., a two- or three-dimensional bounding box. The representation can include state and/or pose information about the sensed object, which can include, a classification (e.g., semantic information), a velocity, a position, an area, a volume, or the like. The representation can also include a confidence value associated with the representation and/or with one or more attributes of the representation. For example, the confidence value may be indicative of a likelihood that the representation accurately represents the sensed object. In examples, the representation is based only on the radar data, e.g., at the exclusion of other types of data. Without limitation, the operations 604, 606 may be performed at least in part in accordance with the techniques described in U.S. patent application Ser. No. 16/587,605 for “Perception System.”

At an operation 608, the process 600 includes determining whether to track the sensed object. In some instances, the operation 608 can include comparing the representation of the sensed object to track information for existing tracks, e.g., as discussed above in connection with FIGS. 2, 3, and 5. In other examples, the determination to track a sensed object may be made independently of any existing tracks. For instance, the operation 608 may include determining to generate a track based on one or more attributes of the representation. For instance, the operation 608 can include determining to generate a track in response to one or more of: a velocity of the sensed object exceeding a threshold velocity, a distance to the sensed object being equal to or less than a threshold distance, a classification of the sensed object corresponding to a predetermined classification (e.g., a vehicle), or the like. In still further examples, the operation 608 can determine to generate a track for the sensed object in response to a confidence value associated therewith being equal to or greater than a threshold confidence. In another example, the operation 608 can determine to generate a track based on a size of the sensed object. For example, tracks may be generated for relatively larger objects at a lower confidence threshold, at a closer proximity, or the like, whereas a smaller object going more slowly and/or at a greater distance may not be tracked. The operation 608 may also consider other details of the radar data, including a fidelity of the radar data, a signal to noise ratio associated therewith, or other data, to determine whether to track an object.

If, at the operation 608 it is determined that the sensed object is not to be tracked, the process 400 may return to the operation 602, e.g., to receive additional radar data from subsequent returns. Alternatively, if, at the operation 608 it is determined that the sensed object is to be tracked, at an operation 610 the process 600 includes generating a track for the sensed object. For example, the operation 610 may be implemented by the track generation component 434. More specifically, the track generation component 434 can predict one or more future states or poses of the sensed object, e.g., at various future time increments, based on the representation. In some instances, the track may be based only on the representation, although in other instances the track may also be based on additional information. For instance, in examples described herein, the operation 610 can include generating a track from a plurality of the representations of the object, e.g., from radar scans taken at different times. Thus, the track may be based only on radar data, e.g., at the exclusion of other types of data from other sensor modalities. In still further examples, the track may be based on other types of data, from other sensor modalities. For instance, additional data from one or more of a lidar sensor, a camera, a time-of-flight sensor, or the like, may be received at the track generation component 434. From this additional data, the track generation component can identify subsets of the data associated with the sensed object, and fuse those subsets with the representation to generate the track in some examples.

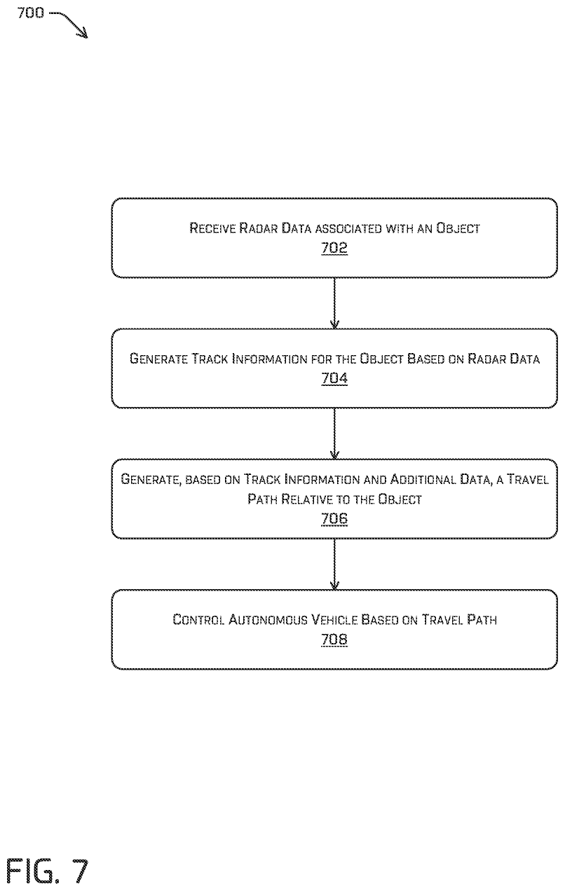

FIG. 7 depicts an example process 700 for controlling an autonomous vehicle based at least in part on radar data, as discussed herein. For example, some or all of the process 700 can be performed by one or more components in FIG. 4, as described herein. For example, some or all of the process 700 can be performed by the perception component 424, the planning component 426, the radar processing system 430 and/or the system controller(s) 428.

At an operation 702, the process 700 can include receiving radar data associated with an object. In examples, the radar data is a representation of radar data, e.g., one of the representations 154 generated from a plurality of radar returns from one or more radar scans.

At an operation 704, the process 700 includes generating track information for the object based on radar data. As in the process 500, the representation of the sensed object based on radar data can be used to generate an updated track for an already-tracked object and/or new tracks for newly-sensed objects.

At an operation 706, the process 700 can include generating, based on the track information and additional data, a travel path relative to the object. For example, the travel path generated at the operation 706 may be determined to travel in a manner that avoids the sensed object, follows the sensed object, passes the sensed object, or the like. In some examples, the additional data can include sensor data from one or more of the sensor system(s) 406. Alternatively, or additionally, the additional data can include additional object representations, e.g., from previously- or subsequently-obtained radar scans.

At operation 708, the process 700 can include controlling an autonomous vehicle to follow the travel path. In some instances, the commands generated in the operation 708 can be relayed to a controller onboard an autonomous vehicle to control the autonomous vehicle to drive the travel path. Although discussed in the context of an autonomous vehicle, the process 700, and the techniques and systems described herein, can be applied to a variety of systems utilizing sensors.

The various techniques described herein can be implemented in the context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks, or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

### EXAMPLE CLAUSES

A: An example system includes: an autonomous vehicle; a radar sensor on the autonomous vehicle; one or more processors; and one or more non-transitory computer readable media storing instructions executable by the one or more processors, wherein the instructions, when executed, cause the system to perform operations comprising: receiving radar data captured by the radar sensor, the radar data comprising a plurality of points having individual velocities and positions; providing the radar data to a machine learned model; receiving, as an output from the machine learned model, a two-dimensional representation of a sensed object, the two-dimensional representation including a sensed velocity and a sensed position of the sensed object; determining, based at least in part on the two-dimensional representation, that the sensed object is not being tracked; generating, based on the two-dimensional representation, an estimated track of the sensed object; and controlling, based at least in part on the track, the autonomous vehicle relative to the estimated track.

B: The system of example A, wherein the estimated track comprises one or more estimated future states of the sensed object.

C: The system of example A or example B, wherein the object data comprises a classification of the sensed object and generating the estimated track of the sensed object comprises predicting the one or more estimated future states of the sensed object based at least in part on the two-dimensional representation and the classification.

D: The system of any one of example A through example C, wherein: the object data comprises a certainty associated with the two-dimensional representation; and the generating the estimated track is based at least in part on the certainty being equal to or exceeding a threshold certainty.

E: The system of any one of example A through example D, wherein the generating the estimated track is based at least in part on a size of the two-dimensional representation, a distance of the two-dimensional representation from the autonomous vehicle, or a velocity associated with the two-dimensional representation.

F: The system of any one of example A through example E, wherein the determining that the sensed object is not being tracked is based at least in part on determining whether the two-dimensional representation is associated with track information associated with one or more tracked objects.

G: An example method includes: receiving a plurality of radar returns associated with an environment; providing the plurality of radar returns to a machine learned model; receiving, as an output of the machine learned model, a multi-dimensional representation of the sensed object based on the plurality of radar returns; and generating, based on the multi-dimensional representation of the sensed object, an estimated track for the sensed object.

H: The method of example G, wherein: the multi-dimensional representation includes a confidence associated with the multi-dimensional representation; and the generating the estimated track is based at least in part on the confidence being equal to or above a threshold confidence value.

I: The method of example G or example H, wherein: the multi-dimensional representation includes at least one of a classification, a sensed velocity, or a sensed position; and the generating the estimated track is based at least in part on the classification corresponding to a predetermined object type, the sensed velocity meeting or exceeding a threshold velocity, or the sensed position being equal to or nearer than a threshold distance.

J: The method of any one of example G through example I, wherein the generating the estimated track is performed in the absence of data other than radar data.

K: The method of any one of example G through example J, further comprising: determining an absence of an existing track associated with the sensed object, wherein the generating the estimated track is based at least in part on the determining the absence of the existing track.

L: The method of any one of example G through example K, wherein the determining the absence of the existing track is based at least in part on a comparison of the multi-dimensional representation with track information associated with the existing track, the comparison comprising at least one of a comparison of a velocity of the multi-dimensional representation with a track velocity, a comparison of a position of the multi-dimensional representation with a track position, or a comparison of an area of the multi-dimensional representation with an area of a tracked object.

M: The method of any one of example G through example L, further comprising: receiving additional data from one or more additional sensors, the one or more additional sensors comprising at least one of a lidar sensor, a time-of-flight sensor, or an imaging sensor; and identifying, in the additional data, a subset of the additional data associated with the sensed object, wherein the generating the estimated track is further based at least in part on the subset of the additional data.

N: The method of any one of example G through example M, wherein the estimated track comprises one or more estimated future states of the sensed object.

O: The method of any one of example G through example N, wherein the object data comprises a classification of the sensed object and generating the estimated track of the sensed object comprises predicting the one or more estimated future states of the sensed object based at least in part on the multi-dimensional representation and the classification.

P: The method of any one of example G through example O, wherein the plurality of radar returns associated with the sensed object are associated with a first time, the method further comprising: generating, based on additional radar returns associated with the sensed object and associated with a second time, a second multi-dimensional representation of the sensed object, wherein the generating the estimated track is based at least in part on the second multi-dimensional representation of the sensed object.

Q: The method of any one of example G through example P, further comprising: generating a trajectory for controlling an autonomous vehicle relative to the new estimated track; and controlling the autonomous vehicle to travel based on the trajectory.

R: The method of any one of example G through example J, wherein the plurality of radar returns are provided to a same layer of the machine learned model such that the machine learned model processes the plurality or radar returns simultaneously.

S: Example non-transitory computer readable media storing instructions that, when executed by one or more processors, cause the processors to perform operations comprising: receiving a plurality of radar returns associated with an environment; providing the plurality of radar returns to a machine learned model; receiving, as an output of the machine learned model, a two-dimensional representation of the sensed object based on the plurality of radar returns and a confidence associated with the two-dimensional representation; and generating, based on the two-dimensional representation of the sensed object and on the confidence value being equal to or exceeding a threshold confidence value, an estimated track for the sensed object.

T: The non-transitory computer readable media of example S, the operations further comprising: determining an absence of an existing track associated with the sensed object, wherein the generating the estimated track is based at least in part on the determining the absence of the existing track.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations described herein need not be performed in the order disclosed, and other examples using alternative orderings of the computations could be readily implemented. In addition to being reordered, in some instances, the computations could also be decomposed into sub-computations with the same results.

What is claimed is:

1. A system comprising:
an autonomous vehicle;
a radar sensor on the autonomous vehicle;
one or more processors; and
one or more non-transitory computer readable media storing instructions executable by the one or more processors, wherein the instructions, when executed, cause the system to perform operations comprising:
receiving radar data captured by the radar sensor, the radar data comprising a plurality of points having individual velocities and positions;
providing the radar data to a machine learned model;
receiving, as an output from the machine learned model, a two-dimensional representation of a sensed object, the two-dimensional representation including a sensed velocity and a sensed position of the sensed object;
determining, based at least in part on the two-dimensional representation, that the sensed object is not being tracked;
generating, based on the two-dimensional representation, an estimated track of the sensed object; and
controlling, based at least in part on the track, the autonomous vehicle relative to the estimated track.

2. The system of claim 1, wherein the estimated track comprises one or more estimated future states of the sensed object.

3. The system of claim 2, wherein the object data comprises a classification of the sensed object and generating the estimated track of the sensed object comprises predicting the one or more estimated future states of the sensed object based at least in part on the two-dimensional representation and the classification.

4. The system of claim 1, wherein:
the object data comprises a certainty associated with the two-dimensional representation; and
the generating the estimated track is based at least in part on the certainty being equal to or exceeding a threshold certainty.

5. The system of claim 1, wherein the generating the estimated track is based at least in part on a size of the two-dimensional representation, a distance of the two-dimensional representation from the autonomous vehicle, or a velocity associated with the two-dimensional representation.

6. The system of claim 1, wherein the determining that the sensed object is not being tracked is based at least in part on determining whether the two-dimensional representation is associated with track information associated with one or more tracked objects.

7. A method comprising:
receiving a plurality of radar returns associated with an environment;
providing the plurality of radar returns to a machine learned model;
receiving, as an output of the machine learned model, a multi-dimensional representation of the sensed object based on the plurality of radar returns; and
generating, based on the multi-dimensional representation of the sensed object, an estimated track for the sensed object.

8. The method of claim 6, wherein:
the multi-dimensional representation includes a confidence associated with the multi-dimensional representation; and
the generating the estimated track is based at least in part on the confidence being equal to or above a threshold confidence value.

9. The method of claim 6, wherein:
the multi-dimensional representation includes at least one of a classification, a sensed velocity, or a sensed position; and
the generating the estimated track is based at least in part on the classification corresponding to a predetermined object type, the sensed velocity meeting or exceeding a threshold velocity, or the sensed position being equal to or nearer than a threshold distance.

10. The method of claim 6, wherein the generating the estimated track is performed in the absence of data other than radar data.

11. The method of claim 6, further comprising:
determining an absence of an existing track associated with the sensed object, wherein the generating the estimated track is based at least in part on the determining the absence of the existing track.

12. The method of claim 10, wherein the determining the absence of the existing track is based at least in part on a comparison of the multi-dimensional representation with track information associated with the existing track, the comparison comprising at least one of a comparison of a velocity of the multi-dimensional representation with a track velocity, a comparison of a position of the multi-dimensional representation with a track position, or a comparison of an area of the multi-dimensional representation with an area of a tracked object.

13. The method of claim 6, further comprising:
receiving additional data from one or more additional sensors, the one or more additional sensors comprising at least one of a lidar sensor, a time-of-flight sensor, or an imaging sensor; and
identifying, in the additional data, a subset of the additional data associated with the sensed object,
wherein the generating the estimated track is further based at least in part on the subset of the additional data.

14. The method of claim 6, wherein the estimated track comprises one or more estimated future states of the sensed object.

15. The method of claim 13, wherein the object data comprises a classification of the sensed object and generating the estimated track of the sensed object comprises predicting the one or more estimated future states of the sensed object based at least in part on the multi-dimensional representation and the classification.

16. The method of claim 6, wherein the plurality of radar returns associated with the sensed object are associated with a first time, the method further comprising:
generating, based on additional radar returns associated with the sensed object and associated with a second time, a second multi-dimensional representation of the sensed object,
wherein the generating the estimated track is based at least in part on the second multi-dimensional representation of the sensed object.

17. The method of claim 6, further comprising:
generating a trajectory for controlling an autonomous vehicle relative to the new estimated track; and
controlling the autonomous vehicle to travel based on the trajectory.

18. The method of claim 6, wherein the plurality of radar returns are provided to a same layer of the machine learned model such that the machine learned model processes the plurality or radar returns simultaneously.

19. Non-transitory computer readable media storing instructions that, when executed by one or more processors, cause the processors to perform operations comprising:
receiving a plurality of radar returns associated with an environment;
providing the plurality of radar returns to a machine learned model;
receiving, as an output of the machine learned model, a two-dimensional representation of the sensed object based on the plurality of radar returns and a confidence associated with the two-dimensional representation; and
generating, based on the two-dimensional representation of the sensed object and on the confidence value being equal to or exceeding a threshold confidence value, an estimated track for the sensed object.

20. The non-transitory computer readable media of claim 19, the operations further comprising:
determining an absence of an existing track associated with the sensed object,
wherein the generating the estimated track is based at least in part on the determining the absence of the existing track.
